(19) United States
(12) Patent Application Publication
(10) Pub. No.: US 2004/0064739 A1
(43) Pub. Date: Apr. 1, 2004

(54) Network accessible apparatus, security method used by the apparatus, and information storage medium that is reproducible by the apparatus

(75) Inventor: Hyun-Kwon Chung, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD, Suwon city (KR)

(21) Appl. No.: 10/673,368

(22) Filed: Sep. 30, 2003

(30) Foreign Application Priority Data
Sep. 30, 2002 (KR) 2002-59400

(51) Int. Cl. G06F 12/14

(52) U.S. Cl. 713/201

(57) ABSTRACT

A network accessible apparatus and security method thereof, include identifying whether a command is a reliable request or an unreliable request, wherein a context issues the command to read a content; reading the content and generating a reliable context corresponding to the content when the command is the reliable request; and reading the content and generating an unreliable context corresponding to the content when the command is the unreliable request.

### CROSS-REFERENCE TO RELATED APPLICATIONS

This application claims the priority of Korean Patent Application No. 2002-59400, filed on Sep. 30, 2002, in the Korean Intellectual Property Office, the disclosure of which is incorporated herein in its entirety by reference.

### BACKGROUND OF THE INVENTION

1. Field of the Invention

The present invention relates to a security model that can be applied to a network accessible apparatus, and more particularly, to a network accessible apparatus, a security method used by the apparatus, and an information storage medium that is reproducible by the apparatus.

2. Description of the Related Art

A network accessible apparatus can read various types of content from a network. For example, a user may access the Internet and read the content thereof using a web browser. The content denotes presentable files, such as text files, image files, moving picture files, Java programs, script programs, and markup documents. The content may be present in local storage media, such as hard disks, or remotely, through the network. When applications such as the markup documents or the Java programs are interpreted and executed, contexts are generated. Accordingly, the contexts denote instances that are presented by analyzing and operating the content.

However, in the case where the contexts are generated from the content retrieved from the network, the contexts should be managed carefully. When the content is retrieved from the network to a local device, a resulting context may detect important user information that is stored in the local device, and choose to transfer the user information to the server of the network or destroy the information. In other words, because a reliability of the content cannot be secured, a novel security method is necessary.

### SUMMARY OF THE INVENTION

The present invention provides, a network accessible apparatus, a security method used by the apparatus, and an information storage medium that is reproducible by the apparatus to enhance security against content that is read from a network.

According to an aspect of the present invention, there is provided a security method, which is applicable to a network accessible apparatus, the security method including: identifying whether a command is a reliable request or an unreliable request, wherein a context issues the command to read a content; reading the content and generating a reliable context corresponding to the content when the command is the reliable request; and reading the content and generating an unreliable context corresponding to the content when the command is the unreliable request.

The present invention also provides a security method, which is applicable to a network accessible apparatus, the security method including: identifying whether a context is a reliable context or an unreliable context, wherein the context issues a command to perform a specific operation; determining that the specific operation is not permitted when the context is an unreliable context; and not performing the specific operation and outputting an error message when the specific operation is not permitted. In the method, the issuing of the command may include identifying a reliability of the context based on a flag of a memory into which the context that issues the command is loaded. The not performing the specific operation may include not performing a preload when the context commands to preload a markup document to secure seamless reproduction of AV data and outputting the error message. The not performing the specific operation may include not performing a deletion when the context commands to delete data that is preloaded in a memory of the network accessible apparatus and outputting the error message. The not performing the specific operation may include not performing access when the context commands to access data that is recorded on a disk mounted in the network accessible apparatus and outputting the error message. The not performing the specific operation may include not performing access when the context commands to access another frame through the not performing the specific operation a frame and outputting the error message. The not performing the specific operation may include not performing access when the context commands to access cookies that are stored in the network accessible apparatus by another context and outputting the error message. The not performing the specific operation may include not performing access when the context commands to access another context that is operated in the network accessible apparatus and outputting the error message. The not performing the specific operation may include not performing control if the context commands to control a reproducing engine, which reproduces AV data recorded on a disk mounted in the network accessible apparatus and outputting the error message.

Another security method according to an aspect of the present invention, which is applicable to a network accessible apparatus, includes: issuing a command by a reliable context to read a content; identifying whether the command is a reliable request or an unreliable request based on syntax of the command; and generating a reliable context corresponding to the content when the command is the reliable request; and generating an unreliable context when the command is the unreliable request. Content corresponding to the reliable context may be recorded on a disk mounted in the network accessible apparatus. The command recorded as an “http://” request in content corresponding to the reliable context may be determined as the reliable request, and the command recorded as an “httpu://” request in content corresponding to the reliable context may be determined as the unreliable request.

In another aspect of the present invention, there is provided an information storage medium that is reproducible by a network accessible apparatus, the information storage medium including an application content storing command information, wherein the command information is interpreted as a reliable request or an unreliable request. The command information may be recorded using syntax to identify whether the command is a reliable request or an unreliable request. According to an aspect of the present invention, the reliable request is recorded as an “http://” request and the unreliable request is recorded as an “httpu://” request.

In another aspect of the present invention, there is provided a network accessible apparatus including: a reader reading a first content from a disk mounted in the apparatus; and a presentation engine reading a second content from a network, wherein the presentation engine generates a first reliable context corresponding to the first content from the disk, and interprets and executes the second content from the network to generate a second reliable context, or interprets and executes the second content from the network to generate an unreliable context.

In the apparatus, the presentation engine identifies the reliability of a context that issues a command to read the second content from the network, to generate the unreliable context corresponding to the second content when the context that issues the command is the unreliable context, and to identify whether the command is a reliable request or an unreliable request when the context that issues the command is a reliable context, to generate the reliable context corresponding to the second content when the command is the reliable request, and to generate an unreliable context corresponding to the second content when the command is the unreliable request. The presentation engine may~examine syntax recorded in the corresponding content to identify whether a command from the first reliable context is a reliable request or an unreliable request.

Another network accessible apparatus according to an aspect of the present invention includes: a reader reading a first content from a disk mounted in the apparatus; and a presentation engine reading a second content from a network, wherein the presentation engine generates a first reliable context corresponding to the content from the disk, and interprets and executes the second content from the network, which is reliably requested by the first reliable context to generate a second reliable context, and interprets and executes the second content from the network, which is unreliably requested by the first reliable context to generate an unreliable context, wherein when a command to perform an operation from the unreliable context is not permitted, the presentation engine does not perform the operation and outputs an error message.

In the apparatus, when a command to preload a markup document to secure seamless reproduction of AV data is received from the unreliable context, the presentation engine does not perform the preload and outputs the error message. When a command to delete data that is preloaded in a memory of the apparatus is received from the unreliable context, the presentation engine does not perform the deletion and outputs the error message. When a command to access data that is recorded on a disk mounted in the apparatus is received from the unreliable context, the presentation engine does not perform the access and outputs the error/message. When a command to access another frame through a frame is received from the unreliable context, the presentation engine does not perform the access and outputs the error message. When a command to access cookies that are stored in the apparatus by another context is received from the unreliable context, the presentation engine does not perform the access and outputs the error message. When a command to access another context that is operated in the apparatus is received from the unreliable context, the presentation engine does not perform the access and outputs the error message. When the command to control the reproducing engine, which reproduces AV data recorded on the disk mounted in the apparatus is received from the unreliable context, the presentation engine does not perform the control and outputs the error message.

Another network accessible apparatus according to an aspect of the present invention includes: a reader reading a first content from a disk mounted in the apparatus; and a presentation engine reading a second content from a network, wherein the presentation engine identifies a reliability of a command to retrieve the first content, which is received from a reliable context generated from the first content read through the reader, based on a syntax of the command, and the presentation engine retrieves the second content from the network and generates a reliable context corresponding to the second content in response to the reliable request, and the presentation engine retrieves the second content from the network and generates an unreliable context corresponding to the second content in response to the unreliable request. The presentation engine may identify an “http://” request as a reliable request and an “httpu://” request as an unreliable request.

Additional aspects and/or advantages of the invention will be set forth in part in the description which follows and, in part, will be obvious from the description, or may be learned by practice of the invention.

### BRIEF DESCRIPTION OF THE DRAWINGS

The above aspects and/or advantages of the present invention will become more apparent by describing in detail exemplary aspects thereof with reference to the attached drawings in which:

FIG. 1 is a block diagram illustrating a security system in which a security method, according to an aspect of the present invention, is realized;

FIG. 2 illustrates a memory structure loaded with a context generated by a reproducing apparatus;

FIG. 3 is a block diagram illustrating the reproducing apparatus, according to another aspect of the present invention;

FIG. 4 describes the context being generated by interpreting and executing a content recorded on a disk of FIG. 3, including markup documents and Java programs;

FIG. 5 is a block diagram illustrating the reproducing apparatus, according to a further aspect of the present invention;

FIG. 6 describes the context being generated by interpreting and executing the content recorded on the disk of FIG. 5, including the markup documents;

FIG. 7 describes the context being generated by interpreting and executing the content recorded on the disk of FIG. 5, including the markup documents and the Java programs;

FIG. 8 is a flowchart illustrating the security method, according to an aspect of the present invention; and

FIG. 9 is a flowchart illustrating the security method, according to another aspect of the present invention.

### DETAILED DESCRIPTION OF THE INVENTION

Reference will now be made in detail to the aspects of the present invention, examples of which are illustrated in the accompanying drawings, wherein like reference numerals refer to like elements throughout. The aspects are described below in order to explain the present invention by referring to the figures.

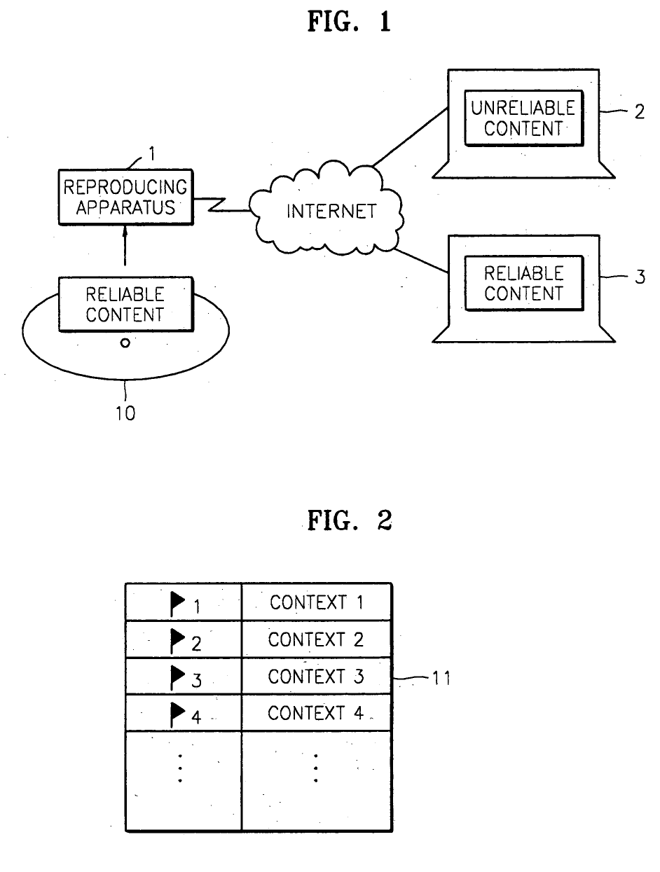

FIG. 1 is a block diagram illustrating a security system in which a security method, according to an aspect of the present invention, is realized.

Referring to FIG. 1, a security system includes a reproducing apparatus 1, according to an aspect of the present invention, which is connected to a network such as the Internet. The reproducing apparatus 1 reads and executes content that is recorded on a disk 10, an example of an information storage medium. In addition, the reproducing apparatus 1 accesses at least one server, 2 and 3, over the Internet to retrieve predetermined content from the servers 2 and 3.

Disk 10 includes some content that is analyzed, operated, presented and generated into a context. The content to generate the context is referred to as an application content. The context is an instance of the application content. Examples of the application content include Java programs, script programs, and markup documents.

The reproducing apparatus 1 identifies whether the content is a reliable content or an unreliable content based on a source of the content. In the present aspect, the reproducing apparatus 1 regards the content read from the disk 10 as the reliable content. In the case of content retrieved from the network, the content reliability is identified by analyzing a command syntax requesting content from the network.

When producing the application content recorded on the disk 10, a content producer also records the command syntax into the content. The command syntax can be analyzed as a reliable command or an unreliable command. For example, when producing a content server as the markup documents, the content server is accessible by link tags and a server reliability is determined. Thereafter, command information that commands to retrieve predetermined content from the unreliable server is recorded using the command syntax that is analyzed into an unreliable request. The command information to retrieve the predetermined content from a reliable server is recorded using the syntax that is analyzed into a reliable request.

The command syntax to request reliability can be determined by various methods. For example, when the application content recorded on the disk 10 includes the markup documents, the reliable request for a predetermined content from the network is recorded as an “http://” request and the unreliable request is recorded as an “httpu://” request.

An example of an “http://” request recorded in a markup document is as follows. When the reproducing apparatus 1 parses the following “http://” request, the reproducing apparatus 1 recognizes that the request is the reliable request.

<a href=“http://www.img.org/coolsite.htm”>trust</a>

An example of an “httpu://” request recorded in a markup document is as follows. When the reproducing apparatus 1 parses the following “httpu://” request, the reproducing apparatus 1 recognizes that the request is the unreliable request.

<a href=“httpu://www.img.org/coolsite.htm”>untrust</a>

When the reliable context requests specific content using the unreliable request, the reproducing apparatus 1 retrieves and executes the corresponding content to generate the unreliable context. When the reliable context requests the specific content using the reliable request, the reproducing apparatus 1 retrieves and operates the corresponding content to generate the reliable context.

The reproducing apparatus 1 performs the commands from the reliable contexts; however, the reproducing apparatus 1 restrictedly performs restricted commands from the unreliable contexts; thereby providing advantages of separating the reliable context from the unreliable contexts. By restrictedly performing the restricted commands from the unreliable contexts, the security of the reproducing apparatus 1 can be maintained.

The unreliable contexts cannot generate reliable contexts in the present aspect of the present invention. In addition, the unreliable contexts are maintained restricted in operations as follows. First, the unreliable context cannot perform cache control operations, such as preload or delete. Preload and deletion will be described later. Second, if the unreliable context is one frame in a structure having a plurality of frames, the unreliable context cannot access another frame. Third, the unreliable context cannot access cookies that are stored in the reproducing apparatus 1 by another context. Fourth, the unreliable context cannot exchange data with another context.

FIG. 2 illustrates a memory structure loaded with the contexts generated by the reproducing apparatus.

Referring to FIG. 2, the contexts generated from the application content, which has been read from the disk 10 or retrieved from the network by the reproducing apparatus 1, is loaded in memory 11 of the reproducing apparatus 1. The reproducing apparatus 1 records flag information to identify whether the contexts are reliable or unreliable. In other words, the contexts loaded in memory 11 include the context data and reliability flags determined from the corresponding context data.

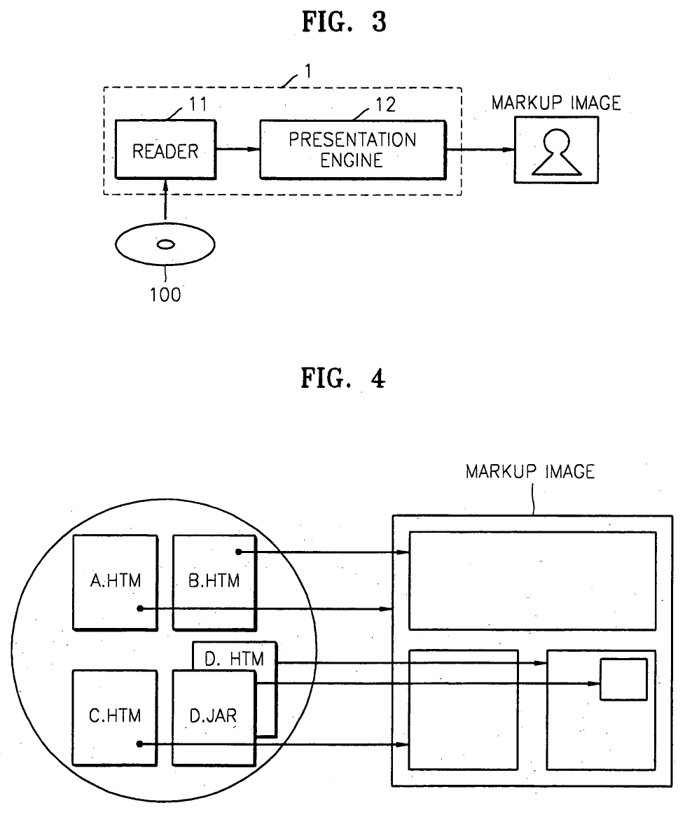

FIG. 3 is a block diagram illustrating the reproducing apparatus 1 of FIG. 1, according to another aspect of the present invention.

Referring to FIG. 3, the reproducing apparatus 1 is illustrated as a player to reproduce the content of a disk 100, including a reader 11 and a presentation engine 12. The content recorded on the disk 100 includes some application content.

The reader 11 reads the application content from the disk 100 and provides the application content to the presentation engine 12. The presentation engine 12 retrieves the application content through the reader 11 or directly from the network, and then interprets and executes the application content to generate the contexts.

In the present aspect, markup documents are recorded on the disk 100. The markup documents denote documents with linked or embedded source code, formed using script languages and Java, and documents using markup languages, such as HTML and XML. In addition, the markup documents are referred by markup resources, which include files linked to the markup documents. The Java programs denote application programs that are operated in a distributed client/server environment, where they are distributed to devices through the network. Furthermore, the Java programs include applets that enable communication with users by forming a portion of a markup image, which is presented by analyzing a markup document.

In the present aspect, the presentation engine 12 analyzes and operates the markup documents and/or the Java programs, retrieved from the disk 100 or the network, and presents the markup images and/or the Java applets to the users.

FIG. 4 describes how the context is generated by interpreting and executing the content recorded on the disk 100 of FIG. 3, including the markup documents and the Java programs.

Referring to FIG. 4, the content of the disk 100 includes markup documents A.HTM, B.HTM, C.HTM, and D.HTM and a Java program D.JAR. The Java program D.JAR includes classes for the Java applets, image files, and sound files that are compressed into one file. The JAR file is defined in the markup document D.HTM as follows.

<applet code=AppletClassName archive=JarFileName width=width height=height/>

AppletClassName denotes the start class name of the Java applet, and JarFileName denotes the name of the JAR file, in which the Java applet classes, the image file, and the sound files are compressed. Width denotes an image width on which the Java applets execute, and height denotes a height of the image on which the Java applets execute.

The markup document A.HTM is interpreted and presented to implement a main frame, and the markup documents B.HTM, C.HTM, and D.HTM are interpreted and presented to implement sub frames. In addition, the Java program D.JAR is interpreted and presented to implement a Java applet, which is located in the sub frame implemented from the markup document D.HTM. In this case, a single context is implemented from the Java applet and generated in units of frame units. As described above, the contents are interpreted, executed, presented, and generated into contexts.

FIG. 5 is a block diagram illustrating the reproducing apparatus of FIG. 1, according to a further aspect of the present invention.

Referring to FIG. 5, the reproducing apparatus 1 includes a reader 31, a presentation engine 32, an AV reproducing engine 33, and a blender 34. Content recorded on a disk 300 includes the markup documents, the Java programs, and AV data. The AV data is recorded in the DVD-Video data format. In the present aspect, application content denotes the markup documents and the Java programs.

The reader 31 provides the AV data recorded on the disk 300 to the AV reproducing engine 33 and provides the markup documents and the Java programs recorded on the disk 300 to the presentation engine 32.

The presentation engine 32 retrieves the content through the reader 31 or directly from the network. The presentation engine 32 interprets and executes the application content to generate contexts. In the present aspect, the presentation engine 32 interprets the markup documents and/or the Java programs to generate corresponding contexts, enabling the presentation engine 32 to form the markup images and/or the Java applets on a screen (not shown). Furthermore, the presentation engine 32 retrieves the AV data from the network and transfers the AV data to the, AV reproducing engine 33. The AV reproducing engine 33 is then able to reproduce the AV data and output AV images.

The blender 34 blends and outputs the AV images and the markup images. Accordingly, the markup images with the AV images embedded therein are displayed on a screen of the reproducing apparatus 1.

A method of displaying the markup image with the embedded AV image is well known to those skilled in the art. For example, PC Friendly DVDs reproduce DVD-Video data and reproduce the AV images using HTML documents by embedding in the markup images, which are generated by interpreting and executing the HTML documents. Furthermore, methods of reproducing AV images with markup images have been developed. For example, Korean Application No. 01-33526 (dated on Jun. 14, 2001), Korean Application No. 01-64943 (dated on Oct. 20, 2001), Korean Application No. 01-65391 (dated on Oct. 23, 2001), and Korean Application No. 02-50524 (dated on Aug. 26, 2002) illustrate such methods.

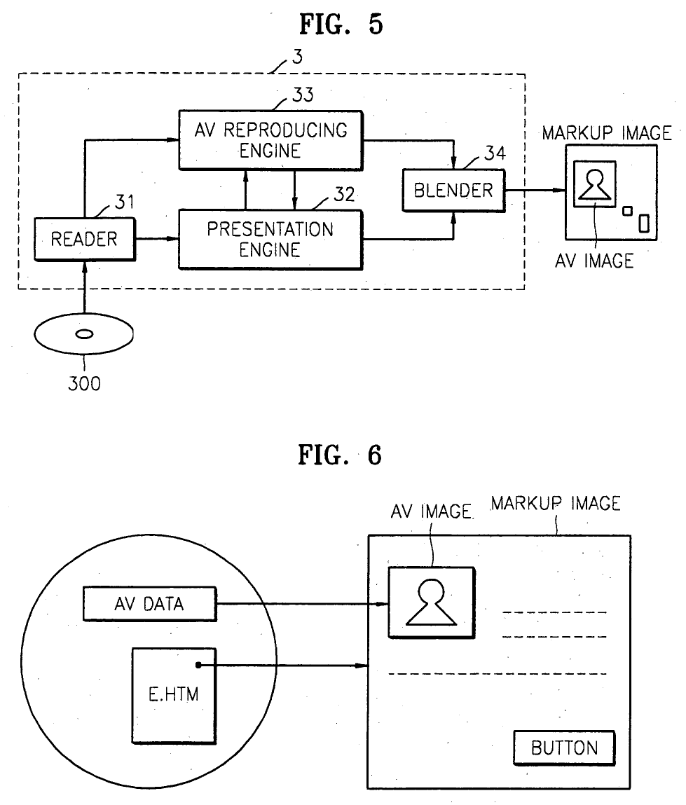

FIG. 6 describes how context is generated by interpreting and executing content recorded on the disk 300 of FIG. 5, including the markup documents.

Referring to FIG. 6, the content recorded on the disk 300 includes the AV data and a markup document E.HTM. The AV data is reproduced by the AV reproducing engine 33 to implement the AV image, and the markup document E.HTM is interpreted and presented to implement a main frame. In this case, the markup image forms the context.

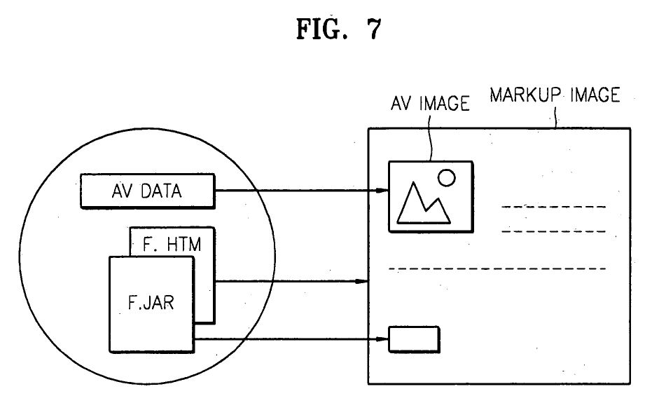

FIG. 7 describes how contexts are generated by reproducing the AV data, and interpreting and executing content recorded on the disk 300 of FIG. 5, including the markup document and the Java program.

Referring to FIG. 7, the AV data, a markup document F.HTM, and a Java program F.JAR are recorded on the disk 300. The AV data is reproduced by the AV reproducing engine 33 to implement the AV image, and the markup document F.HTM is interpreted and presented to implement the main frame. The Java program F.JAR is defined in the markup document F.HTM to implement the Java applet that is operated in the markup image. The markup image and the Java applet are used to generate context. As described above, the application content is interpreted, executed, and presented so that the application content is generated as the contexts.

A security method, according to an aspect of the present invention, will now be described based on the structure described above.

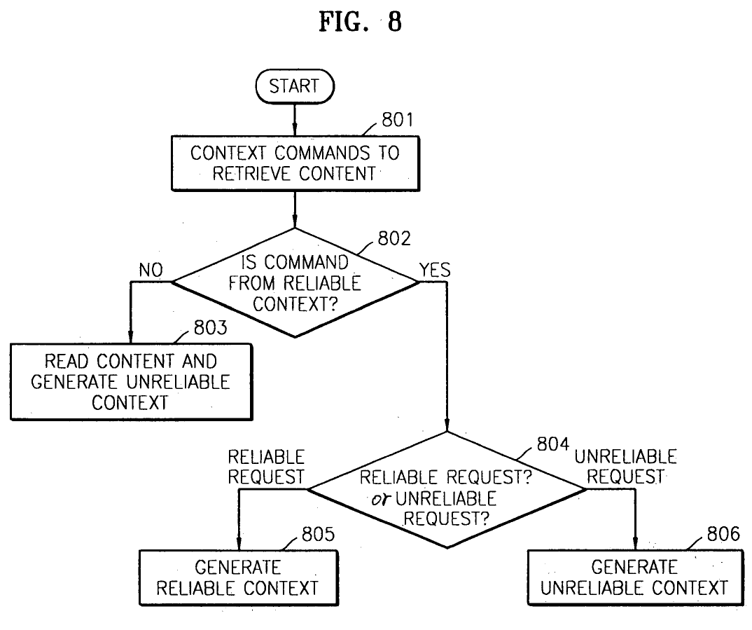

FIG. 8 is a flowchart, illustrating a security method, according to another aspect of the present invention.

Referring to FIG. 8, at operation 801, when a single context issues a command to read the content from the disk 300 or the network, at operation 802, the reproducing apparatus 1 identifies whether the context is a reliable context. The reliability of the context can be identified based on the flag stored in memory 11. If the context is the unreliable context, at operation 803, the reproducing apparatus 1 reads the content and generates the unreliable context corresponding to the content read. At operation 804, if the context is the reliable context, the reproducing apparatus 1 identifies whether the request of the context is the reliable request or the unreliable request. The request reliability can be identified based on the syntax of the command information that is recorded in the markup document, i.e., the content. The reliable request is recorded as an “http://” request, and the unreliable request is recorded as an “http://” request. In the case of the reliable request, at operation 805, the reproducing apparatus 1 reads the content and generates the reliable context corresponding to the content. In the case of the unreliable request, at operation 806, the reproducing apparatus 1 reads the content and generates the unreliable context corresponding to the content.

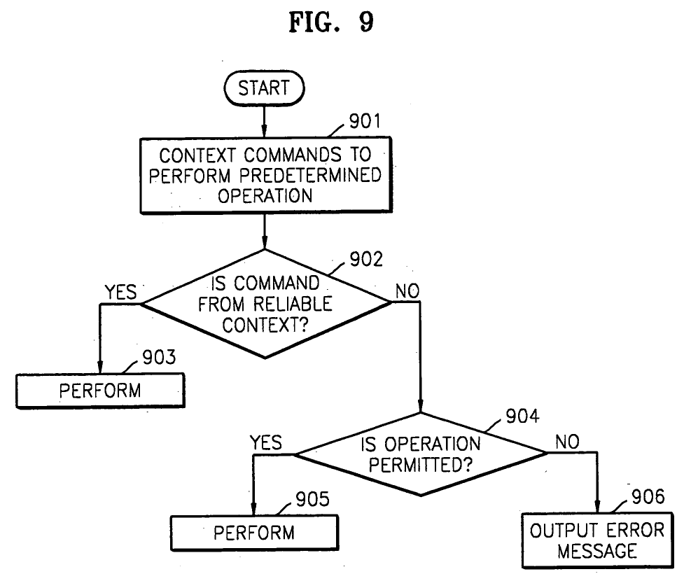

FIG. 9 is a flowchart, illustrating the security method according to still another embodiment of the present invention.

Referring to FIG. 9, at operation 901, when the context commands to operate a predetermined operation, at operation 902, the reproducing apparatus 1 identifies whether the context is the reliable context or the unreliable context. The reliability of the context can be identified based on the flag recorded in memory 11. If the context is the reliable context, at operation 903, the reproducing apparatus 1 executes the command. If the context is the unreliable context, at operation 904, the reproducing apparatus identifies whether the command is permitted or not. The restriction range of the command operation from the unreliable context is predetermined in the reproducing apparatus 1. When the operation is permitted, at operation 905, the reproducing apparatus 1 performs the corresponding operation. When the operation is not permitted, at operation 906 the reproducing apparatus 1 does not perform the corresponding operation and outputs an error message.

Examples of operation 906 are as follows.

First, if the unreliable context commands to preload the markup document to secure a seamless reproduction of the AV data, the reproducing apparatus 1 of FIG. 5 does not perform the preload land outputs the error message. The preload operation denotes preloading markup documents in a memory (not shown) of the reproducing apparatus 1 of FIG. 5. The preload operation is intended to prevent the reproduction of the AV data from failing when reproducing the AV data with the markup documents. The failure is caused by wasting buffered AV data due to a time required in reading the markup documents. If the unreliable context commands to delete the data preloaded in the memory of the reproducing apparatus, the reproducing apparatus 1 does not delete the data and outputs the error message. The preload and the deletion of the preloaded data are disclosed in Korean Application No. 02-57393 titled Information Storage Medium Including Preload Information, Reproducing Apparatus Therefor, and Reproducing Method Thereof filed on Sep. 19, 2002.

Second, if the unreliable context commands to access data recorded on the disk, which is mounted in the reproducing apparatus 1, the reproducing apparatus 1 does not access the data and outputs the error message.

Third, when the unreliable context is one frame of the plurality of frames as shown in FIG. 4, and the unreliable context commands to access another frame, the reproducing apparatus 1 does not access the frame and outputs the error message.

Fourth, if the unreliable context commands to access cookies, which are stored in the reproducing apparatus 1 by another context, the reproducing apparatus 1 does not access the cookies and outputs the error message.

Fifth, if the unreliable context commands to access another context executed in the reproducing apparatus 1, the reproducing apparatus 1 does not access another context and outputs the error message.

Sixth, if the unreliable context commands to control the AV reproducing engine 33, which reproduces AV data stored on the disk 300 mounted in the reproducing apparatus 1 of FIG. 5, the reproducing apparatus 1 does not control the AV reproducing engine 33 and outputs the error message.

As described above, a network accessible apparatus, a security method used by the apparatus, and an information storage medium that is reproduced by the apparatus are provided in a network to enhance security against contexts corresponding to a content read from the network. Accordingly, unreliable contexts corresponding to the content read from the network is prevented from breaking or draining important information stored in the network accessible apparatus.

While this invention has been particularly shown and described with reference to aspects thereof, it will be understood by those skilled in the art that various changes in form and details may be made therein without departing from the spirit and scope of the invention as defined by the appended claims.

What is claimed is:

1. A security method of a network accessible apparatus, the security method comprising:
identifying whether a command is a reliable request or an unreliable request, wherein a context issues the command to read a content;
reading the content and generating a reliable context corresponding to the content when the command is the reliable request; and
reading the content and generating an unreliable context corresponding to the content when the command is the unreliable request.

2. The security method of claim 1, further comprising:
identifying a reliability of the context based on a flag of a memory into which the context that issues the command is loaded.

3. A security method of a network accessible apparatus, the security method comprising:
identifying whether a context is a reliable context or an unreliable context, wherein the context issues a command to perform a specific operation;
determining that the specific operation is not permitted when the context is an unreliable context; and
not performing the specific operation and outputting an error message when the specific operation is not permitted.

4. The security method of claim 3, wherein the issuing of the command comprises identifying a reliability of the context based on a flag of a memory into which the context that issues the command is loaded.

5. The security method of claim 3, further comprising:
not performing a preload when the context commands to preload a markup document to secure seamless reproduction of AV data and outputting the error message.

6. The security method of claim 3, further comprising:
not performing a deletion when the context commands to delete data that is preloaded in a memory of the network accessible apparatus and outputting the error message.

7. The security method of claim 3, further comprising:
not performing access when the context commands to access data that is recorded on a disk mounted in the network accessible apparatus and outputting the error message.

8. The security method of claim 3, further comprising:
not performing access when the context commands to access another frame through a frame and outputting the error message.

9. The security method of claim 3, further comprising:
not performing access when the context commands to access cookies that are stored in the network accessible apparatus by another context and outputting the error message.

10. The security method of claim 3, further comprising:
not performing access when the context commands to access another context that is operated in the network accessible apparatus and outputting the error message.

11. The security method of claim 3, further comprising:
not performing control when the context commands to control a reproducing engine, which reproduces AV data recorded on a disk mounted in the network accessible apparatus and outputting the error message.

12. A security method of a network accessible apparatus, the security method comprising:
issuing a command by a reliable context to read a content;
identifying whether the command is a reliable request or an unreliable request based on syntax of the command; and
generating a reliable context corresponding to the content when the command is the reliable request; and
generating an unreliable context when the command is the unreliable request.

13. The security method of claim 12, wherein the content corresponding to the reliable context is recorded on a disk mounted in the network accessible apparatus.

14. The security method of claim 13, wherein the command recorded as an “http://” request in the content corresponding to the reliable context is determined as the reliable request, and the command recorded as an “httpu://” request in the content corresponding to the reliable context is determined as the unreliable request.

15. An information storage medium that is reproducible by a network accessible apparatus, the information storage medium, comprising:
an application content storing command information, wherein the command information is interpreted as a reliable request or an unreliable request.

16. The information storage medium of claim 15, wherein the command information is recorded using syntax to identify whether the command is a reliable request or an unreliable request.

17. The information storage medium of claim 16, wherein the reliable request is recorded as an “http://” request and the unreliable request is recorded as an “httpu://” request.

18. The information storage medium of claim 17, wherein the “http://” request is a command to read a reliable content from the network.

19. The information storage medium of claim 17, wherein the “httpu://” request is a command to read an unreliable content from the network.

20. A network accessible apparatus, comprising:
a reader reading a first content from a disk mounted in the apparatus; and
a presentation engine reading a second content from a network,
wherein the presentation engine generates a first reliable context corresponding to the first content from the disk, and interprets and executes the second content from the network to generate a second reliable context, or interprets and executes the second content from the network to generate an unreliable context.

21. The apparatus of claim 20, wherein the presentation engine identifies the reliability of a context that issues a command to read the second content from the network, to generate the unreliable context corresponding to the second content when the context that issues the command is the unreliable context, and to identify whether the command is a reliable request or an unreliable request when the context that issues the command is a reliable context, to generate the reliable context corresponding to the second content when the command is the reliable request, and to generate an unreliable context corresponding to the second content when the command is the unreliable request.

22. The apparatus of claim 20, wherein the presentation engine examines flags, corresponding to context loaded into a memory to identify whether the context, which has issued the command to read the predetermined content, is the reliable context or the unreliable, context.

23. The apparatus of claim 20, wherein the presentation engine examines syntax recorded in the corresponding content to identify whether a command from the first reliable context is a reliable request or an unreliable request.

24. A network accessible apparatus, comprising:
a reader reading a first content from a disk mounted in the apparatus; and
a presentation engine reading a second content from a network,
wherein the presentation engine generates a first reliable context corresponding to the content from the disk, and interprets and executes the second content from the network, which is reliably requested by the first reliable context, to generate a second reliable context, and interprets and executes the second content from the network, which is unreliably requested by the first reliable context to generate an unreliable context, and when a command to perform an operation from the unreliable context is not permitted, the presentation engine does not perform the operation and outputs an error message.

25. The apparatus of claim 24, wherein when a command to preload a markup document to secure seamless reproduction of AV data is received from the unreliable context, the presentation engine does not perform the preload and outputs the error message.

26. The apparatus of claim 24, wherein when a command to delete data that is preloaded in a memory of the apparatus is received from the unreliable context, the presentation engine does not perform the deletion and outputs the error message.

27. The apparatus of claim 24, wherein when a command to access data that is recorded on the disk mounted in the apparatus is received from the unreliable context, the presentation engine does not perform the access and outputs the error message.

28. The apparatus of claim 24, wherein when a command to access another frame through a frame is received from the unreliable context, the presentation engine does not perform the access and outputs the error message.

29. The apparatus of claim 24, wherein when a command to access cookies that are stored in the apparatus by another context is received from the unreliable context, the presentation engine does not perform the access and outputs the error message.

30. The apparatus of claim 24, wherein when a command to access another context that is operated in the apparatus is received from the unreliable context, the presentation engine does not perform the access and outputs the error message.

31. The apparatus of claim 24, wherein when the command to control the reproducing engine, which reproduces AV data recorded on the disk mounted in the apparatus is received from the unreliable context, the presentation engine does not perform the control and outputs the error message.

32. A network accessible apparatus, comprising:
a reader reading a first content from a disk mounted in the apparatus; and
a presentation engine reading a second content from a network,
wherein the presentation engine identifies a reliability of a command to retrieve the first content, which is received from a reliable context generated from the first content read through the reader, based on a syntax of the command, and
the presentation engine retrieves the second content from the network and generates a reliable context corresponding to the second content in response to the reliable request, and the presentation engine retrieves the second content from the network and generates an unreliable context corresponding to the second content in response to the unreliable request.

33. The apparatus of claim 32, wherein the presentation engine identifies an “http://” request as a reliable request and an “httpu://” request as an unreliable request.

34. The apparatus of claim 32, wherein the content is at least one of a Java program, a script program, and a markup document that is interpreted and executed by the apparatus.

35. The apparatus of claim 24, wherein the network accessible apparatus performs restricted commands from the unreliable contexts to separate the reliable context from the unreliable contexts.

36. The apparatus of claim 25, wherein when producing a content server as the markup documents, the content server is accessible by link tags and the network accessible apparatus determines server reliability.

37. The apparatus of claim 24, wherein the unreliable context cannot generate reliable contexts.

38. The apparatus of claim 32, wherein the unreliable context cannot perform cache control operations.

39. The apparatus of claim 38, wherein when the unreliable context is one frame in a structure having frames, the unreliable context cannot access another frame.

40. The apparatus of claim 39, wherein the unreliable context cannot access cookies that are stored in the reproducing apparatus 1 by another context.

41. The apparatus of claim 40, wherein the unreliable context cannot exchange data with another context.

42. The apparatus of claim 32, wherein the network accessible apparatus performs restricted commands from the unreliable contexts to separate the reliable context from the unreliable contexts.

43. The apparatus of claim 34, wherein when producing a content server as the markup documents, the content server is accessible by link tags and a server reliability is determined by the network accessible apparatus.

44. The apparatus of claim 32, wherein the unreliable context cannot generate reliable contexts.

45. The apparatus of claim 44, wherein the unreliable context cannot perform cache control operations.

46. The apparatus of claim 45, wherein when the unreliable context is one frame in a structure having frames, the unreliable context cannot access another frame.

47. The apparatus of claim 46, wherein the unreliable context cannot access cookies that are stored in the apparatus by another context.

48. The apparatus of claim 47, wherein the unreliable context cannot exchange data with another context.
